(19) United States
(12) Patent Application Publication
(10) Pub. No.: US 2011/0259282 A1
(43) Pub. Date: Oct. 27, 2011

(54) Transformable, Dual Element Pet Toy

(75) Inventors: Steven Tsengas, Fairport Harbor, OH (US); Justine A. Conklin, Fairport Harbor, OH (US); Jerome A. Spelic, Fairview Park, OH (US)

(73) Assignee: OurPet's Company

(21) Appl. No.: 13/029,510

(22) Filed: Feb. 17, 2011

Related U.S. Application Data
(60) Provisional application No. 61/305,576, filed on Feb. 18, 2010.

(51) Int. Cl. A01K 29/00

(52) U.S. Cl. 119/707

(57) ABSTRACT

A pet toy is provided having multiple elements interconnected or intertwined in a manner that the elements, combined, function as a single toy unit, and when the members are pulled apart or disconnected then each separable element functions similarly on its own. Each toy member is formed as a separate component and forms a generally helical body member terminating at least one end by a thematic caricature formed as a plush doll or plush toy element. The body member is formed of a outer covering having an otherwise generally elongated outer shell adapted such as to create arcuate or compound arcuate centerline such as to urge the body member to wrap about itself or other similar structure. The friction of the outer surfaces provide a fictional, torsion, compression or other non-magnetic or non-adhesive attachment, cling or connection between the toys. The instant abstract is neither intended to define the invention disclosed in this specification nor intended to limit the scope of the invention in any way.

### RELATED APPLICATIONS

The present application claims benefit of U.S. Provisional Application 61/305,576, filed on Feb. 18, 2010 and incorporated by reference as if fully rewritten herein.

### BACKGROUND OF THE INVENTION

1. Field of the Invention

The present invention relates generally to the field of pet or animal toys and, more particularly, to a plurality of plush or chewable pet toy elements that interconnect or transform.

2. Description of the Related Art

Exercise and entertainment of house pets are necessary and healthy activities. Aside from redirecting instinctual behaviors that can be otherwise destructive when confined to a dwelling (such as chewing, scratching, etc.) to maintain cardiovascular health, oral hygiene, and challenge the intelligence and energy of house pets such as dogs and cats a variety of pet toys are available on the market. While in no way exhaustive of a list, such ‘pet toys’ generally can be categorized as:
a. plush toy or other ‘static’ member of generally ornamental design designed to stimulate the pet visually while providing a soft body to chew, toss, scratch, etc.
b. chew-toys made of rubber, rawhide, or other elastomeric or collagen based natural or man-made materials designed specifically to encourage chewing or biting in a manner that both stimulates the pet's sense of taste or smell while promoting cleaning or strengthening of the teeth or bite; and
c. interactive toys that stimulate multiple senses and challenge the pet's instinct or intellect.
   This last group often combines elements of the prior groups in combination with a squeaker, sound module, or other sound source, or light module or other visually discernable element, or motion generator or other maze like structure or edible treat dispenser.

Such interactive toys require the pet to ‘think’ in order to interact with the toy. This has been found to be more effective in stimulating the pet in recent years in that it has been generally found that dogs and cats neurologically exhibit behaviors similar to human infants. (See American Psychological Association, 2009, Aug. 10: Dogs' Intelligence On Par With Two-year-old Human).

In light of this prior art, current plush-type pet toys generally appear very similar to plush-type children's toys. A soft fabric outer covering made of natural or plastic fibers is used to produce a soft, compressible body. Fill or batting is contained inside to create a pillow like structure, and as a result the soft toy can be tossed or tugged without harm to the user or surroundings. To date, differences in pet type plush toys differ from infant type plush toys mostly in the design of the outer covering, as selection of materials. The design for outer coverings of pet toys generally are of themes or colors that stimulate the pet. Materials for pet toys are generally made stronger to resist tearing or biting of the sharp teeth of dogs or cats.

A search of the prior art did not disclose any patents that read directly on the claims of the instant invention; however, the following references were considered related.

U.S. Pat. Nos. D. 258,406 to Elbaum et al. and Hayes 2,961,668 show pillows in figurative forms. In the Hayes patent, the pillow includes simulated head and body portions as well as elongated arms that can be wrapped about the neck of the sleeping child so as to stimulate cuddling of the child by an older person.

In U.S. Pat. No. 4,670,924, issued in the name of Sector, discloses a transformable pillow that provides a transformable dual-function pillow which in its normal slumber mode has the shape of a conventional pillow, and in its transformed mode has a figurative or three-dimensional character form.

While the use of soft filled plush toy elements that would appear to be conventional, other than for the design, are incorporated into this invention in combination, other elements are different enough as to make the combination distinguished over the existing prior art.

Consequently, a need has been felt for providing an apparatus and method of creating an animal toys of plurality of plush or chewable pet toy elements that interconnect or transform with interaction from the pet.

### SUMMARY OF THE INVENTION

It is therefore an object of the present invention to provide an improved pet or animal toy.

It is a feature of the present invention to provide an improved pet or animal toy that incorporates a plurality of plush or chewable pet toy elements that interconnect or transform.

In view of the foregoing, the main object of this invention is to provide a transformable, dual-function pet toy in which multiple members are interconnected or intertwined in a manner that the elements, combined, function as a single pillow or toy unit, and when the members are pulled apart or disconnected then each separable element functions similarly on its own.

A significant advantage of the invention is that the pet toy, as a whole, provides the features and advantages of an individual pet toy, with the added advantage of providing a stimulative interaction with the pet in separating the individual elements. As the individual elements are separated, each can then function with the features and advantages of a separate individual pet toy as well.

Further, the teachings of the present invention can be adapted for use with other conventional pet toy designs and can be integrated with additional interactive mechanisms.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is photograph of a dual element pet toy in a first exemplary ornamental pairing shown as in integrated assembly according to the preferred embodiment of the present invention;

FIG. 2 is photograph of a dual element pet toy in an alternate exemplary ornamental pairing shown as separate components according to the preferred embodiment of the present invention;

FIG. 3 through FIG. 9 are photographs of additional and alternate examples of various different ornamental pairings of dual element pet toys according to the preferred embodiments of the present invention;

FIG. 10 is a cross sectional view taken along line X-X of FIG. 1.

### DESCRIPTION OF THE PREFERRED EMBODIMENTS

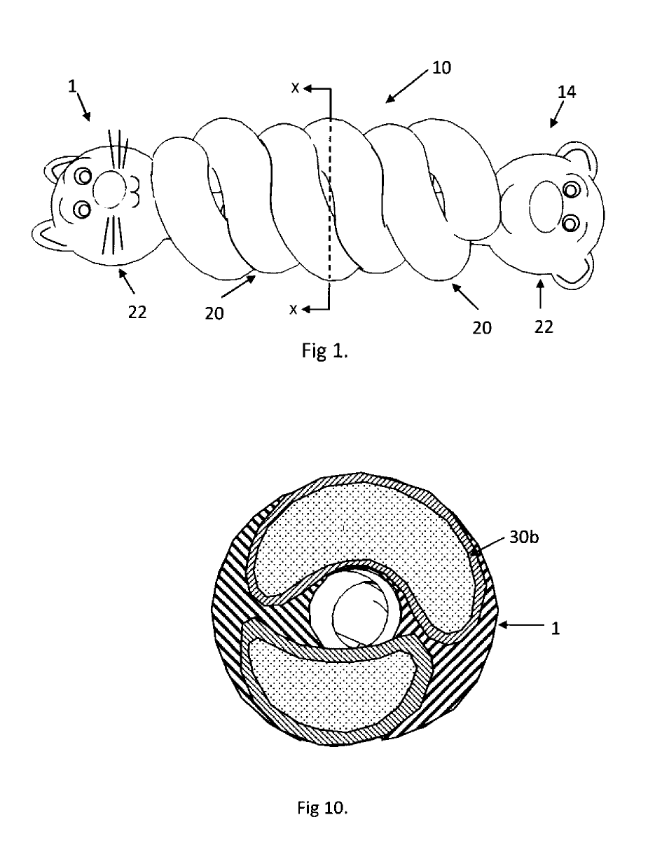

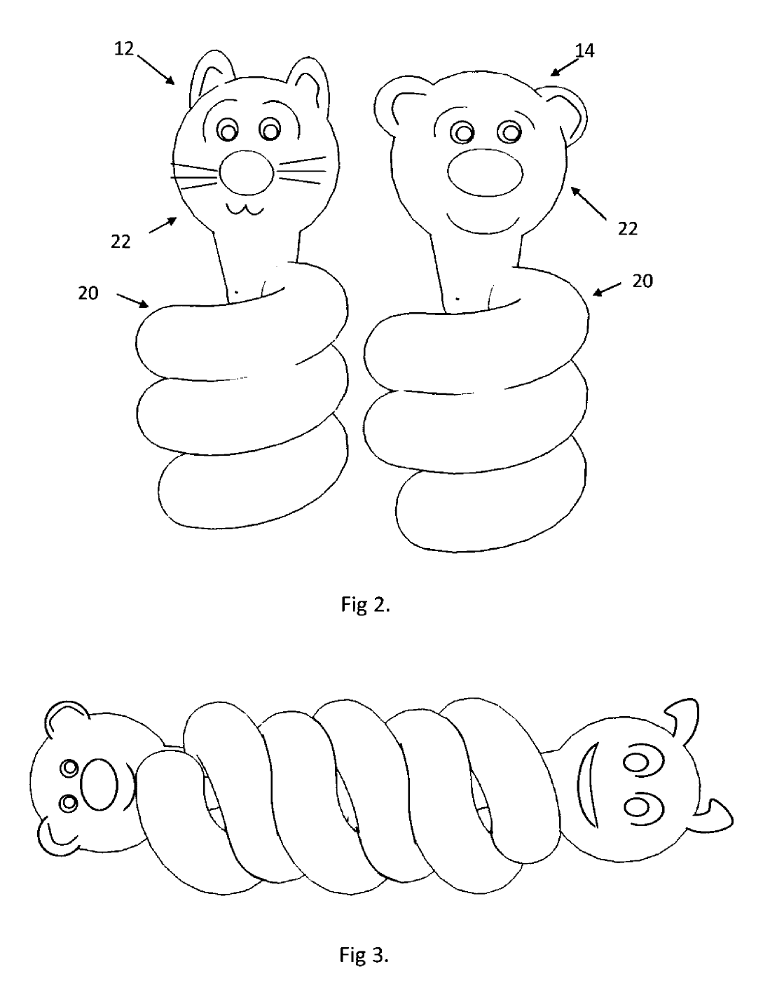

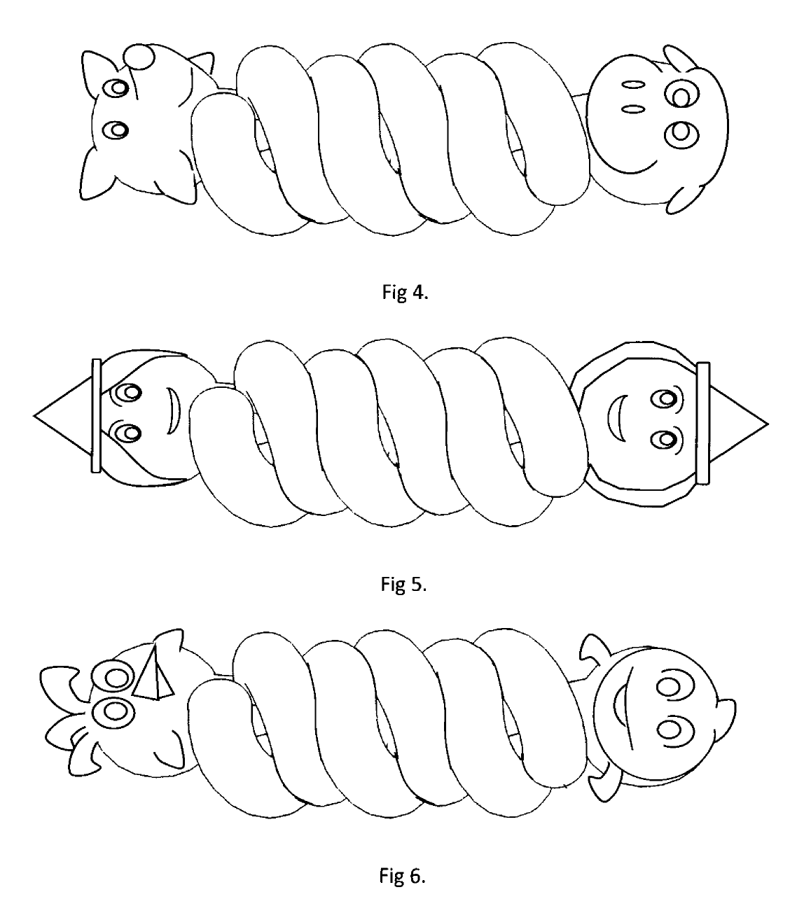

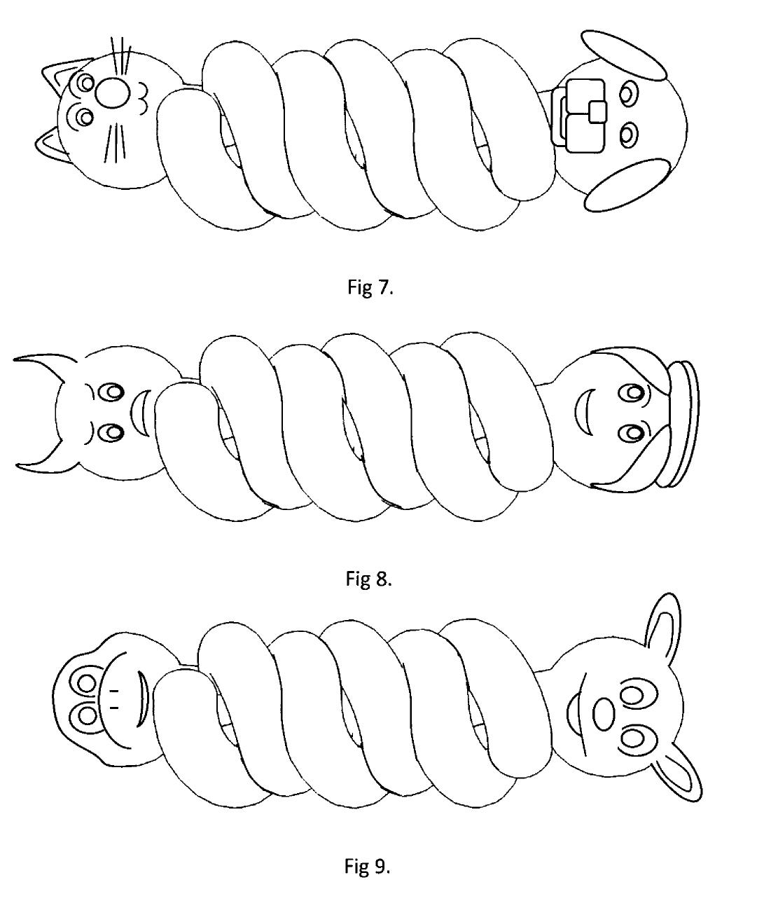

The best mode for carrying out the invention is presented in terms of its preferred embodiment, herein depicted within the FIG. 1 through FIG. 10.

### 1. Detailed Description of the Figures

Referring now to the Figures, a transformable, dual element pet toy 10 is provided having a first toy member 12 in combination with a second toy member 14 capable of being frictionally fit or intertwined. Each toy member 12, 14 is formed as a separate component and forms a generally helical body member 20 terminating at least one end by a terminus 22.

The terminus 22 is formed into a thematic caricature or other type of visually identifiable element. While it is envisioned that the terminus 22 in its preferred embodiment could be formed as a plush doll or plush toy element, the present invention is not intended to be limited solely to such a structure and anticipates that various other pet toy member of any design can be used interchangeably. The body member 20 is formed of a outer covering 30a formed to an otherwise generally elongated outer shell adapted such as to create arcuate or compound arcuate centerline such as to urge the body member 20 to wrap about itself or other similar structure. The outer surface 30b of the body member is anticipated as being formed of a textile fabric. However, the present invention is not intended to be limited solely to such a material and anticipates that various other materials can be used that create a frictional outer surface. By way of example, and not as a limitation, it would be obvious to one skilled in the relevant art, in light of the present teachings, that a flocking or other textured outer surface could provide a functionally equivalent to provide a fictional, torsion, compression or other non-magnetic or non-adhesive attachment, cling or connection between the first toy member 12 and second toy member 14.

It should be noted that the invention is not intended to be limited to the use of plush toys or devices constructed of fabric structures having fluff, fill, batting or other stuffing material. Nor is the invention intended to be limited to any of the exemplary ornamental pairing shown. Rather, a device that broadly integrates the features, benefits and advantageous as described and anticipated above are meant to be broadly embodied.

### 2. Operation of the Preferred Embodiment

In accordance with a preferred embodiment of the present invention, a pet toy would be provided having a plurality of plush or chewable pet toy elements that interconnect or transform. Such an arrangement provides two separate toys that can function with three separate distinctive appearances. It is also envisioned that the individual elements could be provided individually, with the purchaser selecting individual pairings that can be frictionally inherit such as to form the transformable pet toy as shown and described above.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

Having thus described the invention what is claimed as new and desired to be secured by Letters Patent is as follows:

1. A dual element pet toy comprising:
a first toy member in combination with
at least a second toy member, wherein said first toy member and at least one second toy member are capable of being frictionally fit or intertwined.

2. The pet toy of claim 1, wherein said first toy member and said at least second toy member are each is formed as a separate component and each forms a generally helical body member terminating at least one end by a terminus.

3. The pet toy of claim 2, wherein said terminus formed into a thematic caricature or other type of visually identifiable element.

4. The pet toy of claim 3, wherein said visually identifiable element comprises a plush doll or plush toy element.

5. The pet toy of claim 2, wherein each said body member is formed of a outer covering formed to an otherwise generally elongated outer shell adapted such as to create arcuate or compound arcuate centerline such as to urge the body member to wrap about itself or other similar structure.

6. The pet toy of claim 5, wherein said outer surface of the body member comprises a textile fabric.

7. The pet toy of claim 1, wherein said first toy member and said at least second toy member provide a fictional, torsion, compression or other non-magnetic or non-adhesive attachment, cling or connection there between.
